(19) United States
(12) Patent Application Publication
(10) Pub. No.: US 2010/0084259 A1
(43) Pub. Date: Apr. 8, 2010

(54) OPERATION METHOD OF OZONIZER AND OZONIZER APPARATUS USED THEREFOR

(76) Inventors: Masaaki Kato, Tokyo (JP); Rie Kawaguchi, Tokyo (JP)

Correspondence Address: CERMAK KENEALY VAIDYA & NAKAJIMA LLP, 515 EAST BRADDOCK RD SUITE B, Alexandria, VA, 22314, US

(21) Appl. No.: 12/573,156

(22) Filed: Oct. 5, 2009

(30) Foreign Application Priority Data
Oct. 6, 2008 (JP) JP2008-259709

(51) Int. Cl. C01B 13/11; C25B 9/10

(52) U.S. Cl. 204/157.5; 204/252

(57) ABSTRACT

The present invention offers an operation method of an ozonizer and an ozonizer apparatus to improve ozone gas purity and to achieve long and safety electrolysis operation in such manner that, during normal operation of the ozonizer, ozone gas is generated at the anode in the anode compartment and hydrogen gas is generated at the cathode in the cathode compartment; and only when the ozonizer is stopped and operation is switched to protective current operation during which minute electric current is supplied to protect said anode, oxygen-containing gas is supplied to said cathode compartment after electrolyte and hydrogen gas in said cathode compartment are all drained out, so that said cathode is made function as a gas electrode for oxygen reduction reaction, using said cathode as a reversible electrode with two functions as a gas generation electrode and a gas electrode, thereby during normal operation, ozone is generated efficiently, and during the protective current operation, when safety is a key issue, hydrogen gas is not generated at the cathode and mingling of hydrogen gas into ozone gas generated at the anode is prevented.

### CROSS-REFERENCE TO RELATED APPLICATIONS

This application is based upon and claims the benefit of priority of Japanese Patent Application 2008-259709, filed on Oct. 6, 2008; the entire contents of which are incorporated herein by reference.

### BACKGROUND OF THE INVENTION

1. Field of the Invention

The present invention relates to an operation method and an ozonizer apparatus that generates ozone at the anode and hydrogen at the cathode through water electrolysis using a solid polymer electrolyte membrane comprising a cation exchange membrane, to each lateral face of which the anode and the cathode are tightly adhered, which suppress the phenomena of hydrogen gas generated at the cathode permeating to the anode through the cation exchange membrane, enabling, in particular, to prevent deterioration in purity of the anodic gas vented from the electrolytic cell being operated at protective electric current during ozonizer shutdown, thereby achieving safe, continuous operation for a long period of time.

2. Description of the Related Art

The electrolysis system configured by the anode and the cathode adhered to each face, respectively, of the solid polymer electrolyte membrane comprising a cation exchange member is low in electro-conductivity, enabling direct electrolysis of deionized water, which is not electrolyzed with an ordinary method of electrolysis, and bringing advantages, such as a low power cost from decreased electrolytic potential and a compact-size apparatus. In view of this, this type of electrolysis system has been widely used as an energy effective electrolysis system and commercialized as a water electrolysis apparatus for electrolytic generation of oxygen and hydrogen. It is also commercialized as an ozonizer using deionized water as raw material, applying fluorinated ion-exchange membrane as electrolyte as having unique properties.

In such ozonizer as this type, the bonding method between the cation exchange membrane and the electrode catalyst and between the electrode catalyst and the current collector is important to utilize the advantages of the present electrolytic system. The method is roughly divided into two types, Type I and II methods, as below.

Type I is the method in which electrode catalyst is directly supported on the surface of cation exchange membrane. In this method, metal salt adsorbed onto the surface of cation exchange membrane is made in contact with reducing agent to precipitate the metal directly on the surface of cation exchange membrane.

Type II is the method in which electrode catalyst is supported on the surface of current collector. Without the weakness with Type I, Type II has a wide applicable range of candidates for electrode catalyst and even as thick as several tens micron meter can be fabricated. Supporting methods of the electrode catalyst layer include those in which the electrode catalyst layer comprising metals or metal oxides is directly supported on the current collector using electrolytic plating, CVD, spattering, etc., those in which the electrode catalyst layer comprising mixed paste of electrode catalyst powder with resin or organic solvent is applied on the surface of current collector, followed by drying, and those in which metal salt solution is coated on the current collector, followed by thermal decomposition to form metal oxide.

When liquids having a large specific resistance like deionized water are electrolyzed by the water electrolysis apparatus comprising the cation exchange membrane with the electrode catalyst bonded or the current collector with the electrode catalyst bonded by means of either Type I method or Type II method, electrolytic reactions mainly proceed on the interfaces of the cation exchange membrane/electrode catalyst/liquid (three-phase interface). For example, when iridium is applied as electrode catalyst for the anode and platinum-supported carbon is applied as the electrode catalyst for the cathode, oxygen generation reaction proceeds at the three-phase interface of the anode and hydrogen generation reactions proceed at the three-phase interface of the cathode, respectively.

After having developed to a certain size on the three-phase interface, bubbles are vented outside the electrolytic cell through the internal of the current collector from the three-phase interface; on the other hand, while bubbles stay at the three-phase interface, part of generated gas is transferred to the counter electrode through the cation exchange membrane by concentration diffusion effect driven by the internal pressure of bubbles. As an example of such phenomenon, in the zero-gap water electrolysis apparatus, hydrogen gas, generated at the three-phase interface of cathode catalyst/cation exchange membrane/water, reaches to the counter electrode anode through the cation exchange membrane, is mixed with oxygen gas, and vented outside the electrolytic cell.

Transfer of generated gas to the counter electrode leads to performance deterioration of the water electrolysis apparatus, such as lowered purity of generated gas and decreased current efficiency. Moreover, in the water electrolysis apparatus where ozone, oxygen, and hydrogen gases are generated, it may be possible to form a mixture gas of hydrogen, oxygen and ozone in excess of the lower explosion limit of hydrogen (4.65 vol. % as hydrogen content in oxygen) as a result of the counter electrode gas transfer. For safety operation, the water electrolysis apparatus needs to be provided with monitors to watch mingling of counter electrode gas together with operational care.

The relationship between the size of the bubble and the surface tension of liquid is expressed by Young-Laplace Equation: P_{g}−Pl=2 γ/r (Pg: Pressure inside the bubble, Pl: liquid pressure, γ: surface tension of liquid, r: bubble radius) According to this equation, given constant liquid pressure, the smaller the bubble diameter, the larger the pressure inside the bubble to be equilibrium, and therefore, it is known that the force to drive gas transfer to the counter electrode will increase.

According to this relationship, it is considered that the gas volume to permeate the cation exchange membrane will not be affected directly by the gas volume generated from the electrode, but rely on the internal pressure of fine bubbles formed on the three-phase interface and the contact area of bubbles with the cation exchange membrane. Therefore, even in the protective current operation, fine bubbles are generated as in the normal operation and the same amount of gas will permeate the cation exchange membrane, since the number of the three-phase interface and the number of site to generate gas are the same as those at the normal operation at a high current density. At a lower current density operation, the volume of the generated gas from the electrode is also low, and therefore, the gas permeated through the cation exchange membrane will not be diluted and vented from the electrolytic cell at a higher concentration than the case with the high current density operation. In particular, in the apparatus to generate ozone, oxygen, and hydrogen gases, it is possible for the generated gas to be detonative.

Protective current means the current supplied to the electrolytic cell at the electrolysis system shutdown for the purpose of preventing corrosion or quality change of the electrodes, maintaining electrode performance, the volume of which usually is 1/50- 1/1000 the volume at normal electrolysis operation. For instance, in an electrolysis ozonizer where lead dioxide (PbO₂) is used as the anode, if the ozonizer is shutdown without supplying protective current, lead dioxide will be reduced, with hydrogen permeated from the cathode to the anode through the cation exchange membrane or reducing reaction by local battery formed through contact with the anode construction material, to lead oxide (PbO) or lead (Pb) having little ozone generation ability and electro-conductivity or to lead ions eluting into the solution, resulting in a problem of decreased ozone generation capacity at the anode. Generally, a common practice to prevent such corrosive reactions during the electrolysis system shutdown is that the target electrodes are supplied with protective current, to maintain electrode potential not to develop corrosion.

Inventors of the present invention have discussed the cathode gas electrodes to suppress the volume of the counter electrode gas permeated through the cation exchange membrane in order to improve purity of the anode gas generated through electrolysis and, in particular, to obtain an ozonizer capable of running safely even under the protective current operation at the shutdown of the ozonizer.

As a result, inventors of the present invention have found that hydrogen gas generation at the cathode can be suppressed by applying gas electrodes with hydrophilicity and hydrophobicity as cathode, as described in Patent Document 1 and also by supplying oxygen-containing gas to the cathode constantly, and that hydrogen gas which is counter electrode gas does not mix into ozone gas as anodic gas, enabling safe operation at a high current density like at ozone generation by electrolysis, at a low temperature of 60° C. or below.

As gas electrodes applicable for the method in Patent Document 1, precious metal catalyst-supported electrodes developed for oxygen reductive reaction of proton (O₂+4H⁺+4 e⁻→2H₂O) for a solid polymer electrolyte fuel cell can be applied.

### [Prior Technical Document]

### [Patent Document]

### [Patent Document 1] Tokkaihei 5-255879 Patent Gazette

However, the method described in Patent document 1 needs a large volume of oxygen-containing gas to be supplied to the cathode of the apparatus constantly event at the normal operation, for which an oxygen feeding mechanism, such as PSA is necessary and the size of the apparatus becomes very large. Moreover, in the electrolysis method to generate ozone by water electrolysis, such electrolysis conditions are commercially practiced that the temperatures of the electrolytic cell and electrolyte are maintained at around 30° C. to suppress self decomposition of ozone and that the electrolytic current density is controlled to 1 A/cm2 or more to achieve the lowest electric current consumption. These electrolysis conditions are completely different from normal operation conditions of the gas electrodes for oxygen reduction applied to solid polymer electrolyte fuel cells.

As a common operation method for the solid polymer electrolyte fuel cells, operation at reduced cell resistance is preferable to raise power generation efficiency and the operating temperature is raised to around 90° C. to lower the electric resistance of the solid polymer electrolyte. To raise running temperature means to operate electrodes in a high vapor pressure atmosphere, and it becomes preconditions that draining and feeding of water generated by oxygen reduction or the water for giving electric conductivity to solid polymer electrolyte membrane, have to be conducted with moisture vapor. As with the case of oxygen or hydrogen, which is reactant in the fuel cells, if water is handled as vapor, the diffusion layer, which is the supply route of reactant of the gas electrode, is required only to have gas permeation capability.

On the other hand, in the ozone generation by water electrolysis, the atmospheric temperature of the cells or electrolyte is around 30° C., under which most of water remains as liquid because of its small vapor pressure. Therefore, if ordinary gas electrodes are applied, liquid droplets formed by condensate moisture vapor during a long time operation will clog the gas supply channel of the diffusion layer, interfering oxygen gas as reactant from being fed to the three-phase interface of the electrode surface as the reactive site, which may lead to failure as gas electrode in a long time operation.

The typical current density in electrolysis ozone production, 1 A/cm2, is almost the upper limit in current density of the gas electrodes for oxygen reduction commonly applied at present in fuel cells, etc. In addition, as a temperature condition for electrolytic ozone generation, the optimum electrolyte temperature to yield ozone at a high efficiency is around 30° C., which is low in comparison with the operating temperature of fuel cells. Accordingly, as mentioned, when gas electrodes for fuel cells are applied in the electrolytic ozone generation cells, such phenomenon occurs as afore-mentioned that in a long time operation, material transfer path from the electrode surface to the rear face of the electrode will submerge in water condensate, and oxygen gas, reactant, will not be supplied to the three-phase interface of the electrode surface, which is electrolytic reactive site. Moreover, if the amount of condensate increases, even the three-phase interface will submerge in water as liquid. Therefore, in the ozone generation cells, where current density is high and operation temperature is low, if gas cathodes for oxygen reduction are applied for ordinary electrolysis, stable operation for a long time is unable to expect.

Namely, in the ozonizer disclosed in Patent Document 1, where oxygen-containing gas is constantly supplied to the cathode also in the normal operation and the cathode constantly used as gas electrodes, long time stable operation is not possible, which is a weak point of this type of ozonizer.

### SUMMARY OF THE INVENTION

In order to solve said problems, the present invention constitutes the operation method of an ozonizer characterized in that in the ozonizer where the anode for the ozone generation is tightly adhered to one face of the lateral faces of the solid polymer electrolyte membrane comprising cation exchange membrane, in front of which the anode compartment is configured; the cathode for hydrogen generation is tightly adhered to the other face of the lateral faces, in front of which the cathode compartment is configured; ozone gas is generated from said anode in said anode compartment and hydrogen gas is generated from said cathode in said cathode compartment during normal operation; and only when the ozonizer is stopped and operation is switched to protective current operation during which minute electric current is supplied to protect said anode, oxygen-containing gas is supplied to said cathode compartment after electrolyte and hydrogen gas in said cathode compartment are all drained out, so that said cathode is made function as a gas electrode to perform oxygen reduction reaction, thus using said cathode as a reversible electrode with two functions as a gas generation electrode and a gas electrode.

The second means to solve the problem is that in said operation method of said ozonizer, only when the ozonizer is stopped and operation is switched to protective current operation during which minute electric current is supplied to protect said anode, deionized water, air or inert gas is supplied into said cathode compartment and electrolyte and hydrogen gas in said cathode compartment is replaced with said deionized water, air or inert gas, and thereafter oxygen-containing gas is supplied into said cathode compartment.

The third means to solve the problem is that in said operation method of said ozonizer, said cathode is formed by an electro-conductive porous structure comprising platinum or platinum-supported carbon particles dispersed in fluororesin-containing resin.

The forth means to solve the problem is that in said operation method of said ozonizer, said anode is formed by an electro-conductive porous structure comprising a porous metal plate or a metal fiber sintered object, with lead dioxide-contained anode catalyst on its surface.

The fifth means to solve the problem is to construct an ozonizer characterized in that in the operation method of said ozonizer where the anode for the ozone generation is tightly adhered to one face of the lateral faces of the solid polymer electrolyte membrane comprising cation exchange membrane, in front of which the anode compartment is configured; the cathode for hydrogen generation is tightly adhered to the other face of the lateral faces, in front of which the cathode compartment is configured, said cathode is used as a reversible electrode in such manner that during normal operation of said ozonizer, said electrode is used as a gas generation electrode, and during protective current operation when said ozonizer is stopped and minute electric current is supplied to protect said anode, said electrode is used as a gas electrode, thus implementing the operation method of the present invention.

The sixth means to solve the problem is that in said ozonizer, said cathode is formed by an electro-conductive porous structure comprising platinum or platinum-supported carbon particles dispersed in fluororesin-containing resin.

The seventh means to solve the problem is that in said ozonizer, said anode is formed by an electro-conductive porous structure comprising a porous metal plate or a metal fiber sintered object, with lead dioxide-contained anode catalyst on its surface.

### EFFECT OF INVENTION

According to the operation method of the ozonizer and the ozonizer apparatus, by the present invention, a small amount of hydrogen gas or counter electrode gas mingles into anode gas during normal operation, but during protective current operation, when safety is a key issue, hydrogen in anode gas and hydrogen generated in the cathode are made nil, securing safety. Although the cathode is a reversible electrode, which generates hydrogen during normal operation and perform oxygen reduction during protective current operation, the current value at the protective current operation to perform oxygen reduction is 1/50- 1/1000 the value at normal electrolysis and therefore, the required amount of oxygen gas or reactant to be supplied to the three-phase interface of the gas electrode is also limited and running is available with simple methods of replacement and supply.

### BRIEF DESCRIPTION OF THE DRAWINGS

FIG. 1 An overall view illustrating an example of the operation method of the ozonizer and the electrolytic cell used for the ozonizer, by the present invention

FIG. 2 An overall view illustrating an embodiment of the operation method of an ozonizer and the ozonizer apparatus, by the present invention

### DETAILED DESCRIPTION OF THE INVENTION

The following is detailed explanations, in reference to the drawing about the operation method of an ozonizer and the ozonizer apparatus, by the present invention.

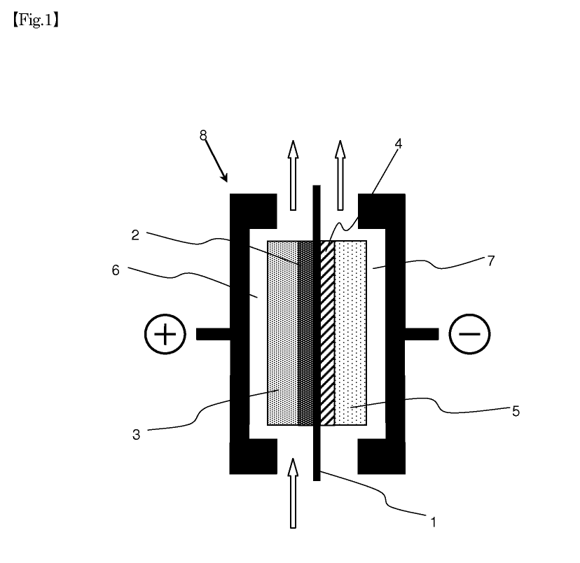

FIG. 1 is a drawing showing one embodiment of the operation method of an ozonizer and the electrolytic cell used for the ozonizer. In the electrolytic cell 8, the anode 2 for ozone generation comprising anode catalyst for ozone generation being supported on the electro-conductive porous structure is tightly adhered to one lateral face of the solid polymer electrolyte membrane 1 comprising the cation exchange membrane, the anode current collector or the anode substrate 3 is provided in front of the anode 2, and the anode compartment 6 is formed in front of said anode current collector or the anode substrate. The cathode 4 for hydrogen generation comprising cathode catalyst for hydrogen generation being supported on the electro-conductive porous structure is tightly adhered to the other lateral face of the solid polymer electrolyte membrane 1 comprising the cation exchange membrane, the cathode current collector or the cathode substrate 5 is provided in front of the cathode 4, and the cathode compartment 7 is formed in front of said cathode current collector or the cathode substrate 5.

For the electrolysis system by the present invention, the solid polymer electrolyte membrane 1 comprising the cation exchange membrane is chosen widely from among conventionally known cation exchange membranes; in particular, perfluorosulfonic acid type cation exchange membrane, having sulfuric acid group, superior in chemical stability being suitable.

To the anode lateral face of the solid polymer electrolyte membrane 1, the anode 2 for ozone generation comprising anode catalyst for ozone generation being supported on the electro-conductive porous structure is tightly adhered, and on its surface, the anode current collector or the anode substrate 3 is positioned in tight contact. For the anode current collector or the anode substrate 3, serviceable materials are chosen from among those having conductive property, corrosion resistance against oxidation and structure sufficiently capable of releasing generated gas and passing electrolyte, such as porous material, mesh material, fiber material, and foaming material of metal substrates including titanium, tantalum, niobium and zirconium.

As the anode catalyst for ozone generation constituting the anode 2 for ozone generation, such material as having oxygen overpotential, like lead dioxide can be used.

The anode 2 for said ozone generation is prepared in such manner that material with high oxygen overpotential, such as lead dioxide, is dispersed in fluororesin-containing resin and supported on the electro-conductive porous structure. The anode 2 is deposited on the anode current collector or the anode substrate 3 by coating or hot-pressing.

Said electro-conductive porous structure is fabricated in such manner that a porous structure is formed with fluororesin, to which electro-conductive particles like carbon or metal fiber is mixed to provide electro-conductive property. As applicable fluororesin in this case, various kinds of fluororesin are usable, among which polytetrafluoroethylene (PTFE) is preferable. As said electro-conductive porous structure, a porous metal plate or a metal fiber sintered object is usable, on which surface, said anode catalyst can be deposited by such means as electrolysis plating, thermal decomposition, coating, and hot pressing.

Meanwhile, the anode 2 can be applied in the formed sheet prepared by said anode catalyst mixed with binder components such as fluororesin or Nafion solution without using said electro-conductive porous structure. As said anode catalyst for ozone generation constituting the anode 2 to generate ozone, electro-conductive diamond can also be used instead of lead dioxide. In this case, electro-conductive porous structure is unnecessary and also the use of anode current collector or the anode substrate 3 can be omitted.

Said anode 2 can be tightly adhered to the surface of said solid polymer electrolyte membrane 1 by hot pressing, instead of being deposited on the anode current collector or the anode substrate 3.

On the cathode lateral face of the solid polymer electrolyte membrane 1, the cathode current collector or the cathode substrate 5 supported by the cathode 4 containing cathode catalyst on its surface is positioned in tight contact. As the cathode current collector or the cathode substrate 5, paper or web state carbon fiber, or porous material of nickel, stainless steel, zirconium, etc. is applicable, as with the anode current collector or the anode substrate. As for the cathode catalyst constituting the cathode 4, platinum, platinum black, and platinum-supported carbon having low hydrogen overpotential is preferable.

The cathode 4 comprises porous structure with said cathode catalyst dispersed in fluororesin-containing resin, which is deposited on the cathode current collector or the cathode substrate 5 or the base material by coating or hot pressing. Also, it can be used in a sheet form mixed with binder component, such as fluoropolymer or Nafion solution, etc. On that occasion, gas permeation can be significantly suppressed and gas purity and current efficiency can also be improved without changing the configuration of the water electrolysis apparatus, in such manner that the surface of said cathode catalyst constituting the cathode 4 is hydrophobized, the constituents are compounded, configured and positioned so that the dispersion element of polytetrafluoroethylene (PTFE) with a high hydrophobicity can effectively function to the uppermost surface.

Said electro-conductive porous structure is fabricated in such way that a porous structure is formed with fluororesin, to which electro-conductive particles like carbon or metal fiber is mixed to provide electro-conductive property. Various kinds of fluororesin can be applied, among which polytetrafluoroethylene (PTFE) is preferable. As said electro-conductive porous structure, porous metal plate or metal fiber sintered object is usable, on which surface, said cathode catalyst can be deposited by electrolysis plating, thermal decomposition, coating, hot pressing, etc.

Meanwhile, the cathode 4 can be used in the form of sheet prepared by said cathode catalyst mixed with binder components such as fluororesin or Nafion solution without using said porous structure. Moreover, the cathode current collector or the cathode substrate 5 can be omitted.

Said cathode 4 can be tightly adhered to the surface of said solid polymer electrolyte membrane 1 by hot pressing, instead of being deposited on the cathode current collector or the cathode substrate 5

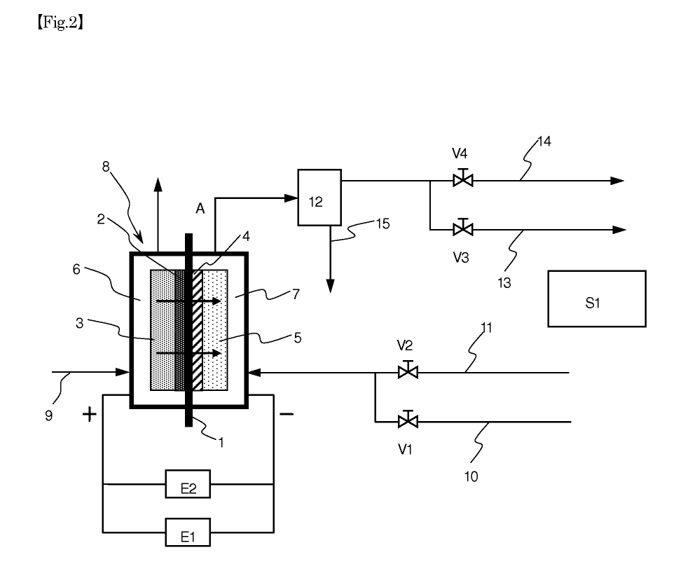

FIG. 2 illustrate one embodiment of the operation method of an ozonizer and an ozonizer apparatus by the present invention in which the DC power line E1 for electrolysis at normal operation and the power line E2 for protective current are connected to the electrolytic cell 8. The pipe 9 supplies deionized water to the anode compartment 6 of the electrolytic cell 8, the pipe 10 supplies oxygen or air to the cathode compartment 7 of the electrolytic cell 8, the pipe 11 supplies deionized water to the cathode compartment 7 of the electrolytic cell 8, the switch valve V1 is for oxygen or air supply and the switch valve V2 is for deionized water supply. The gas-liquid separator 12 is provided at an upper part of the cathode compartment 7, the vent pipe 13 vents oxygen or air, the vent pipe 14 vents hydrogen, the switch valve V3 is for oxygen or air, and the switch valve V4 vent hydrogen. The control unit S1 has timer function to control actions of E1, E2, V1, V2, V3, and V4.

The pipe 10 to supply oxygen or air and the vent pipe 13 for oxygen or air are also used for the supply pipe of air or inert gas and the vent pipe for air or inert gas, at draining out the electrolyte (water transport) and hydrogen gas in said cathode compartment. At this time, electrolyte (transitional water) is drained from the pipe 15 and hydrogen gas is vented from the pipe 14. In case that the electrolyte and hydrogen gas in said cathode compartment are all drained with deionized water, deionized water is supplied through the pipe 11 to the cathode compartment and drained from the pipe 15.

The following explains, in detail, the operation method of the ozonizer and the ozonizer apparatus by the present inventions.

A) First, the performance of normal operation is explained. The electrolysis conditions include the electrode area: 100 cm2 and normal electrolysis current density: 1 A/cm2.
(1) From the DC power line E1 for normal electrolysis operation, 100 A current is supplied to the electrolytic cell 8.
(2) Also, at the same time, current at 1 A is supplied from the DC power line E2 for protective current operation to the electrolytic cell.
(3) To the positive (+) side, deionized water is supplied through the pipe 9 and from the anode compartment 6, mixture gas of oxygen and ozone are vented.
(4) Hydrogen ions and transitional water moves from the anode compartment 6 to the cathode compartment 7.
(5) At the normal operation, hydrogen ions turn to hydrogen gas through cathodic reaction at the cathode 4.
(6) From the cathode compartment 7, hydrogen and electrolyte (water transport) are discharged and subjected to gas-liquid separation at the gas-liquid separator 12.
(7) There is no material supplied from the lines to the cathode compartment 7, V1 and V2 being closed and V4 opened and V3 closed.

As known from the above, the cathode 4 works as hydrogen gas generation cathode and hydrogen gas generates at the cathode 4, at normal operation,

B) Then, the performance at the operation stop is explained.
(1) At the operation stop, the control unit S1 stops E1 and keeps E2 operating.
(2) Then, V2 is opened and deionized water is supplied to the cathode compartment 7 through the pipe 11, and hydrogen gas and electrolyte in the cathode compartment 7 are discharged.
(3) After a specified time period, V2 is closed and V1 is opened to supply oxygen or air to the cathode compartment 7 through the pipe 10. Simultaneously with opening V1, V4 is closed and V3 is opened.
(4) Completion of operation stop procedures As known from the above, the cathode 4 works as a gas cathode at the time of operation stop and hydrogen gas does not generate at the cathode 4.
C) The following is procedures to resume operation.
(1) V1 is closed and V2 is opened. Through the pie 11, deionized water is supplied to the cathode compartment 7 to expel oxygen and air in the cathode compartment 7.
(2) After a specified time lapse, simultaneously with closing V2, V3 is closed and V4 is opened.
(3) From the DC power line E1 for normal electrolysis operation, 100 A current is supplied to the electrolytic cell 8.

Then, after re-start up, operation returns to normal running conditions where the cathode 4 works as hydrogen gas generation cathode and hydrogen gas is generated at the cathode 4.

As afore-mentioned, the present invention makes possible for said cathode 4 to work as a reversible electrode: as a gas generation electrode in normal operation and as a gas electrode at protective current operation during shutdown of ozonizer.

It is advisable to equip hydrogen sensing units to confirm that gas replacement in other than the cathode compartment 7 has been completely carried out in view of safety. Moreover, in the operation method of the ozonizer and the ozonizer apparatus by the present invention, it is advisable to provide measuring units including flow meters of gas and deionized water used for replacement, flow integrators of fluid used for replacement to calculate it from flow rate readings and time of valve opening, and units to measure oxygen and hydrogen concentrations to verify the state of gas replacement for the pipes other than the cell mm.

### EXAMPLES

The following explains examples and comparative examples of the present invention. However, the present invention is not limited to these examples.

### Example 1

A sintered porous titanium plate made of titanium fiber (manufactured by Tokyo Rope Comp. Ltd.), 1 mm thick is degreased by washing with neutral detergent and pretreated by acid washing for one minute with 20% by mass hydrochloric acid solution at 50° C., on which a coating comprising platinum-titanium-tantalum (25-60-15 mol %) is formed by the thermal decomposition method, to constitute the anode current collector or the anode substrate 3, with a foundation layer on the surface.

Using the anode current collector or the anode substrate 3 as the anode, 400 g/l of lead nitrate aqueous solution, as electrolyte was electrolyzed at 1 A/dm2, 60° C. for 60 min. and the anode 2 comprising the coating layer of β-lead dioxide was formed on the surface of the anode current collector or the anode substrate 3.

Commercially available perfluorosulfonic acid type cation exchange membrane (Trade name: Nafion 117 by Du Pont) was applied as the solid polymer electrolyte membrane 1, which was immersed in boiled deionized water for 30 min, for hydro swelling treatment.

On the other hand, after PTFE dispersion (30-J by Du Pont-Mitsui Fluorochemicals Co., Ltd) and dispersion liquid of platinum-supported carbon catalyst dispersed in water are mixed and dried, to which solvent naphtha was added and kneaded. Then, treated by the rolling, drying and calcinations processes, the cathode 4 of porous structure in sheet state comprising PTFE: 40% by mass, platinum-supported carbon catalyst: 60% by mass, 120 μm thick, porosity: 55% was obtained.

Together with these, the stainless fiber sintered object (by Tokyo Rope Comp. Ltd), which is the cathode current collector 5, with 2.5 mm in thickness, is assembled in the Ti electrolysis system in the order of anode compartment 6/anode current collector 3/anode 2 comprising β-lead dioxide coating layer/solid polymer electrolyte membrane 1/cathode 4 comprising cathode sheet/cathode current collector 5/cathode compartment 7, and deionized water electrolysis (normal electrolysis) was performed under temperature control at 30±5° C. Then, mixture gas of ozone and oxygen was generated at the anode, and hydrogen gas was generated at the cathode. The ozone concentration in the anodic gas was 11.0 vol. %, the concentration of hydrogen gas generated at the cathode 4, permeated through the solid polymer membrane 1 and mingled with the anodic gas (ozone gas) was 0.05 vol. %, and the cell voltage was 3.3 V Electrolysis conditions included current density: 1 A/cm2, electrolyte temperature: 30±5° C., effective electrolytic area: 1 dm2.

Then, after the current density was switched to the protective current density at 0.01 A/cm2, deionized water was supplied to the cathode compartment and electrolyte and gas in the cathode compartment were replaced; after the replacement, air is supplied to the cathode compartment at 0.5 lit/min. by the air pump; the concentration of hydrogen in the anodic gas was ‘non-detected’; and the concentration of hydrogen in vent gas from the cathode compartment was also ‘non-detected’. The cell voltage was 0.5V.

The electrolysis conditions of the following examples and comparative examples were all the same as those of the example 1.

### Example 2

After performing electrolysis in an ordinary manner as with Example 1, the operation was switched to the protective current mode, electrolysis water and gas in the cathode compartment was replaced with deionized water, and after the replacement, PSA concentrated oxygen (oxygen conc. at 96%) was supplied to the cathode compartment at 0.3 lit./min. Hydrogen concentration in the anodic gas was ‘non-detected’ and hydrogen concentration in the vent gas from the cathode compartment was also ‘non-detected’. The cell voltage was 0.4V.

### Example 3

After performing electrolysis in an ordinary manner as with Example 1, the operation was switched to the protective current mode, air was supplied to the cathode compartment at 0.5 lit./min using an air pump and then the water in the cathode compartment was drained. Hydrogen concentration in the anodic gas was ‘non-detected’ and hydrogen concentration in the vent gas from the cathode compartment was also ‘non-detected’. The cell voltage was 0.5V.

### Comparative Example 1

After performing electrolysis in an ordinary manner as with Example 1, the operation was switched to the protective current mode and left as it was. Hydrogen concentration in the anodic gas was 1 vol. % and hydrogen concentration in the vent gas from the cathode compartment was 100 vol. %. The cell voltage was 2.2V.

### Comparative Example 2

After performing electrolysis in an ordinary manner as with Example 1, the operation was switched to the protective current mode, air was supplied to the cathode compartment at 0.5 lit./min using an air pump and then the water in the cathode compartment was drained. Hydrogen concentration in the anodic gas was ‘non-detected’ and hydrogen concentration in the vent gas from the cathode compartment was also ‘non-detected’. The cell voltage was 0.5V The air pump was stopped and left as it was. In three days, hydrogen concentration in the anodic gas was 0.8 vol. % and hydrogen concentration in the vent gas from the cathode compartment was 100 vol. %. The cell voltage was 2.0V.

### INDUSTRIAL APPLICABILITY

The operation method of the ozonizer and the ozonizer apparatus, by the present invention can produce ozone efficiently in the normal operation period; while at the time of protective current operation during which safety is usually most problematic, there was no mingling of hydrogen gas into ozone gas generated at the anode because hydrogen gas was not generated at the cathode, and therefore the operation method of the ozonizer and the ozonizer apparatus, by the present invention can improve the purity of ozone gas and achieve safe electrolysis operation for a long time.

### FIGURE LEGEND

1: solid polymer electrolyte membrane comprising cation exchange membrane
2: anode
3: anode current collector or anode substrate
4: cathode
5: cathode current collector or cathode substrate
6: anode compartment
7: cathode compartment
8: electrolytic cell
9, 10, 11, 13, 14, 15: pipe
12: gas-liquid separator
V1, V2, V3, V4: switch valve
E2: DC power for protective current
E1: DC power for normal electrolysis
S1: Control unit

1. An operation method of an ozonizer characterized in that in the ozonizer in which the anode for ozone generation is tightly adhered to one face of the lateral faces of a solid polymer electrolyte membrane comprising a cation exchange membrane, in front of which the anode compartment is configured and the cathode for hydrogen generation is tightly adhered to the other face of the lateral faces, in front of which the cathode compartment is configured, ozone gas is generated at said anode in said anode compartment and hydrogen gas is generated at said cathode in said cathode compartment, during normal operation of said ozonizer; and only when the ozonizer is stopped and the operation is switched to protective current operation during which minute electric current is supplied to protect said anode, electrolyte and hydrogen gas are all drained out and thereafter, oxygen-containing gas is supplied to said cathode compartment to make said cathode function as a gas electrode to perform oxygen reduction reaction, applying said cathode as a reversible electrode with two functions as a gas generation electrode and a gas electrode.

2. An operation method of an ozonizer as defined in claim 1, characterized in that only when the ozonizer is stopped and the operation is switched to protective current operation during which minute electric current is supplied to protect said anode, deionized water, air or inert gas is supplied into said cathode compartment, and after electrolyte and hydrogen gas in said cathode compartment are all replaced with deionized water, air or inert gas, oxygen-containing gas is supplied to said cathode compartment.

3. An operation method of an ozonizer as defined in claim 1, characterized in that said cathode is formed by an electro-conductive porous structure comprising platinum or platinum-supported carbon particles dispersed in fluororesin-containing resin.

4. An operation method of an ozonizer as defined in claim 1, characterized in that said anode is formed by an electro-conductive porous structure comprising a porous metal plate or a metal fiber sintered object, with lead dioxide-contained anode catalyst on its surface.

5. An ozonizer to implement the operation method as defined in claim 1, characterized in that in the ozonizer in which the anode for ozone generation is tightly adhered to one face of the lateral faces of a solid polymer electrolyte membrane comprising a cation exchange membrane, in front of which the anode compartment is configured and the cathode for hydrogen generation is tightly adhered to the other face of the lateral faces, in front of which the cathode compartment is configured, said cathode is used as a reversible electrode in such manner that during normal operation of said ozonizer, said electrode is used as a gas generation electrode, and during protective current operation when said ozonizer is stopped and minute electric current is supplied to protect said anode, said electrode is used as a gas electrode.

6. An ozonizer as defined in claim 5, characterized in that said cathode is formed by an electro-conductive porous structure comprising platinum or platinum-supported carbon particles dispersed in fluororesin-containing resin.

7. An ozonizer as defined in claim 5, characterized in that said anode is formed by an electro-conductive porous structure comprising a porous metal plate or a metal fiber sintered object, with lead dioxide-contained anode catalyst on its surface.
